(19) United States
(12) Patent Application Publication
(10) Pub. No.: US 2002/0127467 A1
(43) Pub. Date: Sep. 12, 2002

(54) Non-aqueous electrolyte secondary

(76) Inventors: Shunji Watanabe, Miyagi (JP); Yoshimi Kanno, Miyagi (JP); Shinichi Takasugi, Miyagi (JP); Tsugio Sakai, Miyagi (JP)

Correspondence Address: ADAMS & WILKS, 31st Floor, 50 Broadway, New York, NY, 10004, US

(21) Appl. No.: 09/966,718

(22) Filed: Sep. 27, 2001

(30) Foreign Application Priority Data
Sep. 28, 2000 (JP) 2000-296059
Apr. 16, 2001 (JP) 2001-117212
Jul. 13, 2001 (JP) 2001-214053
Sep. 25, 2001 (JP) 2001-291278

(51) Int. Cl. H01M 10/04

(52) U.S. Cl. 429/90; 29/623.2; 29/623.4

(57) ABSTRACT

A non-aqueous electrolyte secondary battery capable of being assembled by reflow soldering is provided. The assembled non-aqueous electrolyte secondary battery is heat-treated following the temperature-time profile close to that for the reflow soldering, and then provided with the terminals by welding.

### BACKGROUND OF THE INVENTION

1. Field of the Invention:

This invention relates to a coin-shaped (or button-shaped) non-aqueous electrolyte secondary battery capable of being assembled by reflow soldering, with a substance capable of occluding/releasing lithium, metallic lithium or alloy negative electrode as the negative electrode active material, substance capable of occluding/releasing lithium as the positive electrode active material, and lithium ion-conductive non-aqueous electrolyte, and a method of producing the same.

2. Description of the Related Art:

The coin-shaped (or button-shaped) non-aqueous electrolyte secondary battery has been increasingly used as a back-up power source for various types of equipment, because of their favorable characteristics, e.g., high energy density and lightness.

When such a battery is used mainly as a memory back-up power source, it has been frequently provided with terminals by welding and then mounted on the printed board together with the memory devices by soldering. A soldering bit has been used to solder electronic component members on a printed board. However, it has been increasingly difficult to secure the space for a soldering bit, as number of electronic component members per unit area of the printed board increases to satisfy the requirements for compactness and advanced functions. Moreover, the automatic soldering work has been increasingly demanded to reduce the cost.

To solve the above problems, a soldering cream or the like is applied beforehand to a portion of the printed substrate on which a member is set, or a small solder sphere is supplied to a member set on the printed board to be soldered, and then the substrate is passed through a high-temperature atmosphere in a furnace controlled to heat the soldering portion at the solder melting point or higher, e.g., 200 to 260° C., to mount the member by soldering after melting the solder (this method is hereinafter referred to as reflow soldering).

The coin-shaped (or button-shaped) non-aqueous electrolyte secondary battery capable of being assembled by reflow soldering uses an organic solvent for the electrolytic solution, metal oxide for the positive electrode and negative electrode active material incorporated with lithium by an adequate method during the production step for the negative electrode. These components are frequently active, due to nature of the battery itself. Therefore, changed ratios of these components, resulting from fluctuations of the production step, may cause troubles during the reflow soldering step for mounting the battery on the product substrate, e.g., blistering of the battery and leakage of the electrolytic solution out of the battery.

It is necessary to guarantee the battery quality of the coin-shaped (or button-shaped) non-aqueous electrolyte secondary battery capable of being assembled by reflow soldering, after it is reflow-soldered. Fluctuations of the production step may increase quantities of foreign matter (e.g., moisture) in the battery, although slightly. The characteristics of such a battery, although remaining essentially unchanged at room temperature, may rapidly deteriorate after the battery is reflow-soldered or stored.

### SUMMARY OF THE INVENTION

The present invention provides a method of producing a non-aqueous electrolyte secondary battery having the positive electrode, negative electrode, electrolytic solution containing a non-aqueous solvent and supporting salt, separator and gasket, comprising a step of assembling and sealing the positive electrode, negative electrode, non-aqueous solvent, electrolytic solution, separator and gasket in the non-aqueous electrolyte secondary battery by caulking, and step of heating. The battery may be provided with terminals by welding to connect itself to an outside device, after it is heated. It can withstand temperature of 180 to 300° C.

The present invention also provides a method of mounting a non-aqueous electrolyte secondary battery on a circuit substrate, comprising a step of assembling and sealing the positive electrode, negative electrode, non-aqueous solvent, electrolytic solution, separator and gasket in the non-aqueous electrolyte secondary battery by caulking, step of heating, and reflow soldering step to mount the non-aqueous electrolyte secondary battery on the circuit substrate on which it is set. The battery may be provided with connecting terminals by welding, after it is assembled. It is preferable that the difference between the temperature-time profile during the heating step and that during the reflow soldering step is within ±50% in a heating region of 0 to 150° C.

It is also preferable that the difference between heating step time and reflow soldering step time is within ±50% in a heating region of 0 to 150° C.

It is still preferable that the difference between the temperature-time profile during heating step time and that during reflow soldering step time is within ±20% in a heating region of 150 to 180° C.

It is still preferable that the difference between heating step time and reflow soldering step time is within ±20% in a heating region of 150 to 180° C.

It is still preferable that the difference between the temperature-time profile during the heating step and that during the reflow soldering step is within ±10% in a heating region of 180 to 300° C.

It is still preferable that the difference between heating step time and reflow soldering step time is within ±10% in a heating region of 180 to 300° C.

In the present invention, a sealant of rubber-based adhesive with asphalt on the surface is used for the non-aqueous electrolyte secondary battery, wherein the adhesive is preferably dotted on the surface with the asphalt, these dots being apart from each other.

It is also preferable that the asphalt is a heated fraction of asphalt, and that the rubber-based adhesive also has the asphalt inside.

It is also preferable that the asphalt is present at 1 to 50%, inclusive, more preferably 5 to 20%, inclusive, in the rubber-based adhesive.

The asphalt is preferably blown or straight asphalt.

Butyl-based rubber is suitable for the rubber-based adhesive.

The method adopted for the present invention to produce the sealant for the non-aqueous electrolyte secondary battery heats the rubber-based adhesive incorporated with asphalt, wherein the rubber-based adhesive is preferably butyl rubber-based. It is recommended that the adhesive is incorporated with the asphalt in the presence of an organic solvent, preferably toluene.

The present invention produces the non-aqueous electrolyte secondary battery comprises a step of assembling and sealing the positive electrode, negative electrode, non-aqueous solvent, electrolytic solution, separator and gasket in the non-aqueous electrolyte secondary battery by caulking, after a solution of the rubber-based adhesive and asphalt dissolved in an organic solvent is spread over the inner surfaces of the positive electrode can and dried, and step of heating. The asphalt is preferably straight asphalt. It is also preferable that the solution is dried at 80° C. or higher. The asphalt may be blown asphalt. When blown asphalt is used, the solution is suitably dried at 100° C. or higher.

When the battery can surface is marked to show that the heating step is over, the heated final product can be distinguished from the intermediate one.

The non-aqueous electrolyte secondary battery of the present invention having the positive electrode, negative electrode, electrolytic solution containing a non-aqueous solvent and supporting salt, separator, gasket and terminals which connects the battery to an outside device is marked to show that it is subjected heating once during the production process.

The non-aqueous electrolyte secondary battery of the present invention has the positive electrode, negative electrode, electrolytic solution containing a non-aqueous solvent and supporting salt, separator and gasket, wherein it is heated at an around reflow temperature.

The method of the present invention produces the non-aqueous electrolyte secondary battery capable of being assembled by reflow soldering by heat-treating the assembled battery following the temperature-time profile close to that for the reflow soldering step, in order to solve the above problems involved in the conventional techniques. The batteries thus produced were examined for their battery characteristics and outer appearances. Those passed the examinations were marked with the production number and letter “H” indicating that the battery was heat-treated, and provided with the terminals by welding.

The battery can be heat-treated after being provided with the terminals by welding, but care must be taken in this case, when the terminals are solder-plated, to prevent troubles, e.g., deposition of the solder to the vessel during the heat treatment step.

### BRIEF DESCRIPTION OF THE DRAWINGS

FIG. 1 presents the cross-sectional view of the non-aqueous electrolyte secondary battery of the present invention capable of being assembled by reflow soldering; and

FIG. 2 presents the temperature-time profile for the reflow soldering step.

### DESCRIPTION OF THE PREFERRED EMBODIMENTS

The non-aqueous electrolyte secondary battery capable of being assembled by reflow soldering uses lithium, lithium alloy, lithium-doped oxide or lithium-doped carbon for the negative electrode. Lithium is a very active metal, and, when its content varies (e.g., doubled) resulting from fluctuations of the production step, may cause troubles during the reflow soldering step, e.g., very unstable temperature, and blister or even rupture of the battery.

The positive electrode of the battery is of manganese-, molybdenum- or titanium-based oxide. A manganese-based oxide is especially active, and must be carefully handled to control its quantity, when it is used for the positive electrode.

Quantity of the electrolytic solution must be controlled fairly finely, while it is being injected. Even when a high-melting electrolytic solution is used, it can cause troubles when injected in an excessive quantity, e.g., volumetric expansion during the reflow soldering step and leakage out of the battery.

As discussed above, the compositional fluctuations during the production process may cause troubles, e.g., blister, leakage of the electrolytic solution and even rupture of the battery at the worst during the reflow soldering step to mount the battery on the product substrate. Blister of the battery during the reflow soldering step generally floats one of the terminals from the substrate, although depending on the terminal structure, to disconnect the electroconductive path, with the result that the battery no longer works. When the electrolytic solution leaks out of the battery, the supporting salt contained therein works together with moisture in air to corrode the substrate circuit. The rupture of the battery may lead to damages of the substrate or other electronic devices, possibly causing great damages to the product on which the battery is to be mounted.

It is necessary to minimize fluctuations of the production step as far as possible in order to prevent these troubles, which needs large expenses. For example, an expensive electrolytic solution injection system may be required to increase injection accuracy, or various sensors may be needed to monitor quantity of each component. Nevertheless, however, one or more of these measures may not guarantee that these troubles are completely prevented.

It is also necessary to guarantee the characteristics of the non-aqueous electrolyte secondary battery capable of being assembled by reflow soldering, after it is reflow-soldered. Fluctuations of the production step may slightly increase quantities of foreign matter (e.g., moisture) in the battery. The characteristics of such a battery, although remaining essentially unchanged at room temperature, may rapidly deteriorate after the battery is reflow-soldered or stored. Unexpected deterioration of the characteristics of the reflow-soldered battery may result, when quantity of its electrolytic solution is insufficient.

The battery was heat-treated once under the conditions close to those for the reflow soldering, in order to solve these problems. The heat-treated batteries of composition not up to specification, resulting from fluctuations or abnormality of the production step, can be removed by observing their outer appearances and battery characteristics (battery voltage, internal resistance and height). The reflow soldering will neither rupture the battery, once it is heat-treated, nor greatly changes the battery characteristics.

The heat-treatment step preferably adopts the temperature-time profile as close to that for the actual reflow soldering step as possible. It is recommended to effect the heat treatment under severer conditions with respect to temperature and time than those for the reflow soldering step, in order to minimize possibility of the battery rupture during the reflow soldering step.

The heat treatment is preferably effected at least once. Safety with respect to rupture will increase as number of the heat treatment step increases. It should be noted, however, that the battery characteristics tend to deteriorate as it is more exposed to heat.

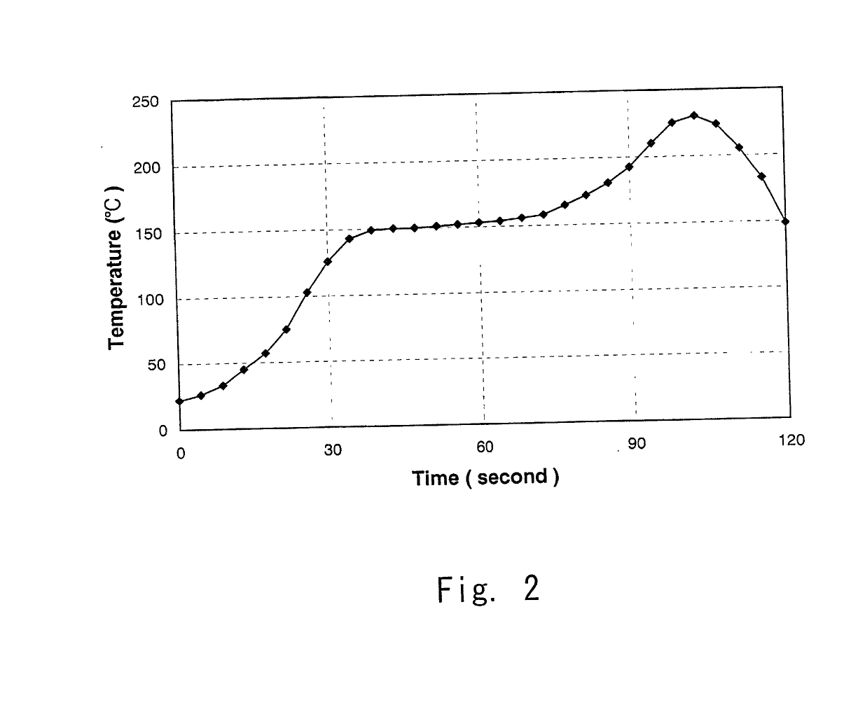

FIG. 2 presents a typical temperature-time profile for the reflow soldering step, wherein temperature is that on the battery surface. The temperature-time profile for the heat treatment step is preferably as close to the above profile as possible. The profiles for these steps may be different from each other to some extent in a low temperature region, but should be as close to each other as possible in the high temperature region around the peak temperature. This is because the highest attainable temperature during the heat treatment step is the most important parameter for the treated battery characteristics: the abnormal batteries may not be sufficiently screened when it is too low, and the batteries may be damaged when it is too high. It is experimentally confirmed that the sufficient effect can be realized when the temperature-time profile for heat treatment step differs from that for the reflow soldering step within ±50% in a region of 0 to 150° C., within +20% in a region of 150 to 180° C., and within ±10% in a region of 180° C. or higher, both in time and temperature.

It is a very good practice to put some mark on the screened battery after it is heat-treated and examined for its outer appearances and battery characteristics (battery voltage, internal resistance and height), to help confirm whether it is heat-treated or not and check this by a customer. For example, it may be marked with an ink or provided with a laser marker.

The battery can be heat-treated after being provided with the terminals by welding, but care must be taken in this case, when the terminals are solder-plated, to prevent troubles, e.g., deposition of the solder to the vessel during the heat treatment step. The battery judged to be defective after being provided with the terminals by welding and heat-treated wastes cost, because it takes more member(s) and additional step of welding than the battery itself judged to be defective.

It is found that the electrolytic solution for the present invention is stable at the reflow temperature, when a non-aqueous solvent having a boiling point of 200° C. or higher at normal pressure is used therefor. The reflow temperature may go up to around 250° C., but no rupture of the battery is observed even when it uses, as the solvent, γ-butyrolactone (γBL) having a melting point of 204° C. at normal pressure, conceivably because of increased pressure within the battery at such a high temperature. Propylene carbonate (PC), ethylene carbonate (EC) or γ-butyrolactone (γBL), either individually or in combination, produces a good result in a combination with the positive electrode and negative electrode.

A polymer may be used, in addition to the above-described organic solvents. The polymers useful for the present invention are those which have been commonly used, e.g., polyethylene oxide (PEO), polyvinylidene oxide, and crosslinked polyethylene glycol diacrylate, polyvinylidene fluoride, crosslinked polyphosphazene, polypropylene glycol diacrylate, polyethylene glycol methyl ether acrylate and polypropylene glycol methyl ether acrylate.

Typical impurities present in the electrolytic solution (with non-aqueous solvent) include moisture and organic peroxides (e.g., glycols, alcohols and carboxylic acids). Each of these impurities may help form an insulating coating film on a graphitized surface, which conceivably increases interfacial resistance of the electrode, and hence deteriorates cycle life and capacity. It may also accelerate self-discharging, when the battery is stored at high temperature (60° C. or higher). It is therefore preferable to minimize these impurities present in the electrolyte containing a non-aqueous solvent. More concretely, it is preferable to control moisture content at 50 ppm or less, and organic peroxide content at 1000 ppm or less.

One or more lithium salts (electrolytes) are used as supporting salts. These salts include lithium perchlorate (LiClO₄), lithium phosphotetrafluoride (LiPF₆), lithium borofluoride (LiBF₄), lithium arsenohexafluoride (LiAsF₆), lithium trifluorometasulfonate (LiCF₃SO₃), lithium bistrifluoromethylsulfonylimide [LiN(CF₃SO₂)₂], thiocyanate and fluoride salt of aluminum. It is found that a fluorine-containing supporting salt, e.g., lithium phosphotetrafluoride (LiPF₆), lithium borofluoride (LiBF₄) or lithium trifluorometasulfonate (LiCF₃SO₃) is more stable thermally and in electrical characteristics than a chlorine-based one, e.g., lithium perchlorate (LiClO₄) in the reflow soldering step. The supporting salt is preferably dissolved in a non-aqueous solvent at 0.5 to 3.0 mol/L.

A solid electrolyte with a mixture of polymer and supporting salt is produced by removing the solvent. The polymer and supporting salt are dissolved in acetonitrile or 1,2-dimethoxy ethane, and the resultant solution is spread over the surfaces of the separator for the present invention, and dried. Another method disperses polypyrrole in a solvent which dissolves PEO and a supporting salt, and then removes the solvent. The composite, e.g., POE-PMMA with a methacrylate ester as the skeleton can be produced by polymerization of a mixture of the monomer and supporting salt.

The separator uses a membrane which has high ion permeability and required mechanical strength and is electrically insulating. The glass fiber is most stable during the reflow soldering step, but a resin having a thermal deformation temperature of 230° C. or higher, e.g., polyphenylene sulfide, polyethylene terephthalate, polyamide or polyimide, may be also used. The separator is provided with holes, whose size is in a range normally used for a battery, e.g., 0.01 to 10 μm. Its thickness is in a range normally used for a battery, e.g., 5 to 300 μm.

For a gasket, polypropylene or the like is normally used. For the battery subjected to reflow soldering, it is found that the gasket of a resin having a thermal deformation temperature of 230° C. or higher causes no troubles, e.g., rupture at the reflow temperature and leakage of the electrolytic solution resulting from deformation of the gasket while the reflow-soldered battery is stored. These resins include polyphenylene sulfide, polyethylene terephthalate, polyamide, liquid crystal polymer (LCP), tetrafluoroethylene/perfluoroalkylvinyl ether copolymer resin (PFA), polyetheretherketone resin (PEEK) and polyethernitrile resin (PEN).

The other resins useful for the present invention include polyetherketone, polyallylate, polybutylene terephthalate, polycyclohexanedimethylene terephthalate, polyether sulfone, polyaminobismaleimide, polyetherimide, and fluorine-based resins. It is experimentally confirmed that the above resin brings the similar effect, when incorporated with glass fibers, mica whiskers, fine ceramic particles or the like at around 10% by weight or less.

The gasket can be produced by, e.g., injection molding or thermal compression molding. Injection molding is the most common method for producing gaskets. However, when forming accuracy is sacrificed for, e.g., reducing cost, a liquid sealant must be used to compensate for decreased air tightness.

Thermal compression molding is a method which produces the final formed article by thermal compression molding of a plate-shaped material thicker than the final gasket at its melting point or lower.

A thermoplastic resin shape, formed by thermal compression molding of the stock shape at its melting point or lower, tends to return to the original shape when exposed to temperature. Such a gasket for the non-aqueous electrolyte secondary battery capable of being assembled by reflow soldering, which otherwise would inherently have a gap between the metal (outer and inner cans) and resin (gasket) or could not produce a sufficient stress to seal the gap between these cans and gasket, expands to close the gap or produces a sufficient stress to seal the gap. Its tendency to return to the original shape is also useful for a battery other than a reflow-soldered one. The gasket of tetrafluoroethylene/perfluoroalkylvinyl ether copolymer resin (PFA), in particular, shows better sealing characteristics when produced by compression molding of the sheet-shaped stock material under elevated temperature and pressure than by injection molding. This is because PFA has rubber elasticity, and the gasket produced by thermal compression molding tends to return to its original shape before molding at the reflow temperature, to have better sealing and air-tight characteristics due to increased pressure at the sealed section. The injection-molded gasket, on the other hand, shrinks at the reflow temperature.

A coin- or button-shaped battery is sealed for the gap between the positive electrode and negative electrode with, e.g., asphalt, hydrocarbon-based rubber (e.g., butyl rubber), fluorine-based oil, chlorosulfonated polyethylene, epoxy resin or a combination thereof, which may be diluted, as required, to facilitate application. The liquid sealant may be colored, when it is transparent, to clearly indicate that is applied. The sealant can be applied by, e.g., injection into the gasket, spreading over the positive electrode and negative electrode can surfaces, or dipping in the gasket sealant solution.

Mixing of asphalt can be carried out by mixing asphalt in a solvent. In the case of using an adhesive of a hydrocarbon-base rubber as a sealing agent, asphalt and the adhesive of the hydrocarbon-base rubber may be dissolved in toluene followed by mixing. The solution thus prepared can be used by coating on the surface of the positive pole can, which is brought into contact with the gasket and coating on the surface of the gasket, which is brought into contact with the negative pole can followed by drying. AS the solvent in the case of using the adhesive of the hydrocarbon-base rubber as the sealing agent, toluene or xylene was effective.

It is effective to mix asphalt with the above-described liquid sealant, or hydrocarbon-based rubber. Adhesion of the gasket to the battery case will greatly improve, when the assembled battery is heated. Improved adhesion of the gasket to the battery case will greatly enhance battery storage characteristics and prevent leakage of the electrolyte, although it is not clear whether the improvement results from increased stickiness of the asphalt itself or of the hydrocarbon-based rubber incorporated in asphalt under heating.

The non-aqueous electrolyte secondary battery capable of being assembled by reflow soldering is sealed by a gasket of hard engineering plastic, and tends to be less air-tight at the sealed section than the one not reflow-soldered, and hence lower in storage characteristics and higher in risk of electrolytic solution leakage. Therefore, the battery of the present invention will have greatly improved storage characteristics and resistance to electrolytic solution leakage while it is being assembled in a device by reflow soldering, when delivered after assembled with an asphalt-containing sealant and heat-treated. It can maintain, needless to say, the improved storage stability and resistance to electrolytic solution leakage after it is reflow-soldered.

The asphalt may be straight asphalt, or blown asphalt produced by oxidative polymerization of straight asphalt, the latter being particularly effective for its tackiness coming from the asphaltenes it contains a lot.

The effective addition amount of asphalt is at least 2% by weight to the main components of the sealing agent. Even when at least 50% by weight of asphalt to the main components of the sealing agent is added, the battery performance is good, but the liquid sealing agent oozed at the production of battery becomes sticky, which gives the possibility of lowering productivity. Also, when at least 50% by weight is added, the sealing agent itself becomes soft, whereby the sealing agent sometimes oozed outside at using the battery to cause stains in appearance.

Accordingly, the usable addition amount of asphalt is from 2% by weight to 50% by weight, and particularly preferably from 5 to 20% by weight. More preferably, in the range of from 5 to 10% by weight. The heating temperature may be at least a temperature of softening the liquid sealing agent mixed with asphalt. In the case of mixing straight asphalt, the heating temperature is preferably at least 80° C. and in the case of mixing blown asphalt, it is preferably at least 100° C. It is effective that the heating is carried out in the heat-treatment process of the invention of the application, which was once carried out under the condition near practical reflow soldering.

For the coin- or button-shaped battery, a mixture of positive electrode or negative electrode active material is compressed into pellets to have the electrode of desired shape. For the thin coin- or button-shaped battery, the electrode may be formed by die-cutting the sheet-shaped electrode material. The pellet dimensions (thickness and diameter) is determined by size of the battery.

The pellets can be pressed by a common method, but preferably by pressing in a mold. Pressing pressure is not limited, but preferably in a range of 0.2 to 5 ton/cm², and pressing temperature is preferably in a range of room temperature to 200° C.

A mixture for electrode may be incorporated with an additive, e.g., electroconductive agent, binder or filler. The electroconductive agent type is not limited; it may be metallic powder, but more preferably carbon-based material. The carbon-based one is more common than others, and the examples include natural graphite (flaky, leafy or earth-like), synthesized graphite, carbon black, channel black, thermal black, furnace black, acetylene black and carbon fiber. The metals useful for the electroconductive agents include powdered or fibrous copper, nickel and silver. Electroconductive polymers are also useful.

Carbon content of the mixture varies depending on electroconductivity of the electrode active material and electrode shape, and is not limited. But, it is preferably 1 to 50% by weight, more preferably 2 to 40%, for the negative electrode.

The carbon particles have an average size of 0.5 to 50 μm, preferably 0.5 to 15 μm, more preferably 0.5 to 6 μm, to increase contact area between the electrode active material particles, help form the electron conducting networks, and decrease ratio of the electrode active material which is not involved in the electrochemical reactions.

The binder for the present invention is not limited, but is preferably insoluble in the electrolytic solution. The binders useful for the present invention normally include polysaccharides, thermoplastic resins, thermosetting resins, and polymers of rubber elasticity, e.g., polyacrylic acid, neutralized polyacrylic acid, polyvinyl alcohol, carboxymethyl cellulose, starch, hydroxypropyl cellulose, recycled cellulose, diacetyl cellulose, polyvinyl chloride, polyvinyl pyrrolidone, tetrafluoroethylene, polyvinylidene fluoride, polyethylene, polypropylene, ethylene/propylene/diene polymer (EPDM), sulfonated EPDM, styrene/butadiene rubber, polybutadiene, fluorine-based rubber, polyethylene oxide, polyimide, epoxy resin and phenol resin. They may be used either individually or in combination. Content of the binder is not limited, but preferably in a range of 1 to 50% by weight.

The filler for the present invention is not limited, so far it is fibrous and triggers no reaction in the assembled battery. Fibrous carbon or glass can be used for the present invention. Its content is not limited, but preferably in a range of 0 to 30% by weight.

The current collector for the electrode active material is preferably of metallic plate of low electrical resistance. For example, the positive electrode is made of stainless steel, nickel, aluminum, titanium, tungsten, gold, platinum or sintered carbon, or aluminum or stainless steel surface-treated with carbon, nickel, titanium or silver. Of stainless steel types, two-phase one is effective against corrosion. In the coin- or button-shaped battery, the outboard electrode is plated with nickel by an adequate method. The treatment methods include wet and dry plating, CVD, PVD, cladding by pressing, and coating.

The negative electrode is made of stainless steel, nickel, copper, titanium, aluminum, tungsten, gold, platinum or sintered carbon; copper or stainless steel surface-treated with carbon, nickel, titanium or silver; or Al-Cd alloy. The treatment methods include wet and dry plating, CVD, PVD, cladding by pressing, and coating.

The electrode active material can be immobilized on the collector by an electroconductive adhesive. The electroconductive adhesive may be of powdered or fibrous carbon or metal incorporated in a resin dissolved in a solvent, or electroconductive polymer dissolved in a solvent.

The electrode terminal is of a metal, mainly of around 0.1 to 0.3 mm thick plate-shaped stainless steel. The terminal circuit substrate and section on which a battery component member is to be set by soldering are frequently plated with, e.g., gold, nickel or solder. Welding of the battery is effected by, e.g., resistance or laser-aided welding.

In the case of the pelletized electrode, the adhesive is applied to a space between the collector and pelletized electrode, to immobilize the electrode on the collector. The electroconductive adhesive frequently contains a thermosetting resin.

The areas to which the non-aqueous electrolyte secondary battery of the present invention are applicable are not limited, and include back-up power sources for portable telephones and pagers, and power sources for watches having a power generation function.

It is preferable that the battery of the present invention is assembled in a dehumidified or inert atmosphere. It is also preferable that the component members to be assembled are dried beforehand. The pellets, sheet and other members may be dried or dehydrated by a common method, preferably by the aid of hot air, vacuum, infrared ray, far-infrared ray, electron beams or low-humidity air, either individually or in combination, at 80 to 350° C., preferably 100 to 250° C. Moisture content is preferably 2000 ppm or less based on the whole battery, and 50 ppm or less based on the mixture for the positive electrode and negative electrode and electrolyte, in order to improve its charge/discharge cycle characteristics.

Heating the pellets themselves is especially effective. Heating is effected preferably at 180 to 280° C. in a vacuum, atmospheric or inert atmosphere. Adequate heating time is 1 hour or more. One measure for setting the heating temperature is the reflow soldering temperature or higher. It is necessary to set the heating conditions while taking strength of the organic binder into consideration. Heating each member beforehand at the reflow soldering temperature or higher effectively prevents the rapid reactions when the assembled battery is exposed to the reflow soldering temperature. The heating also promotes impregnation of the pellets with the electrolytic solution, which is very advantageous for improving the characteristics of the battery of the present invention, because it uses a high-melting, viscous electrolytic solution.

The present invention is described more concretely by the following Examples.

### EXAMPLE 1:

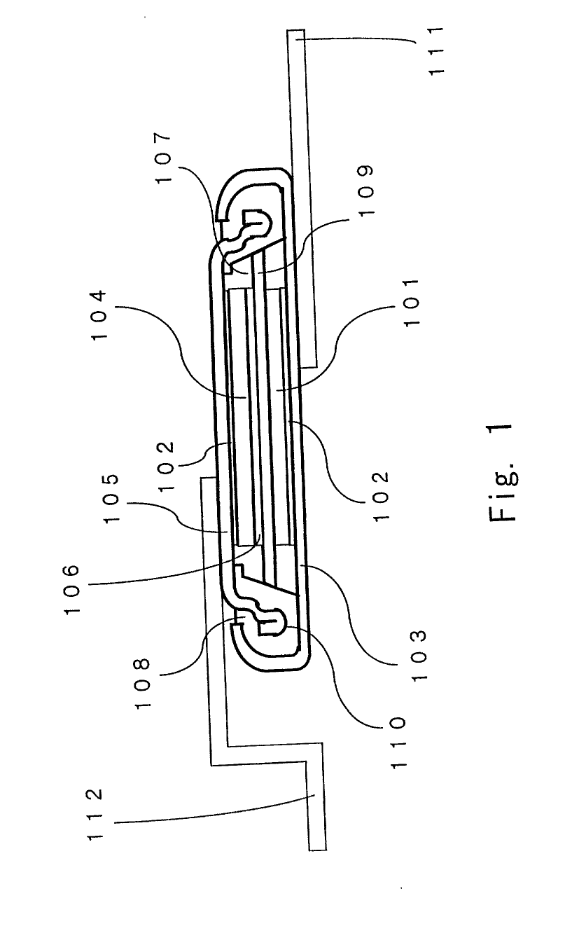

Example 1 used MoO₃ and WO₂ as the positive electrode and negative electrode active materials, respectively. The positive electrode, negative electrode and electrolytic solution were prepared by the procedures described below. The battery was 4.8 mm in outer diameter and 1.4 mm thick. FIG. 1 presents its cross-sectional view.

In Example 1, the mixture for positive electrode material was prepared by incorporating commercial MoO₃, after it was crushed, with graphite as the electroconductive agent and polyacrylic acid as the binder in a ratio of 53/45/2 by weight, and 5 mg of the mixture was pressed into a pellet, 2.4 mm in diameter, under pressure of 2 ton/cm². The positive electrode unit of monolithic structure was prepared, wherein the pellet 101 thus prepared and electrode collector 102 were assembled in and bound to the positive electrode case 103. It was treated at 250° C. under a vacuum for 8 hours for drying.

The mixture for negative electrode material was prepared by incorporating commercial WO₂ as the working electrode active material, after it was crushed, with graphite as the electroconductive agent and polyacrylic acid as the binder in a ratio of 45/40/15 by weight. 2.6 mg of the mixture was pressed into a pellet, 2.4 mm in diameter, under pressure of 2 ton/cm². The negative electrode unit of monolithic structure was prepared, wherein the pellet 104 thus prepared and electrode collector 2 composed of an adhesive of electroconductive resin with carbon as the electroconductive filler were assembled in and bound to the negative electrode case 105. It was treated at 250° C. under a vacuum for 8 hours for drying. The laminated electrode of lithium and negative electrode pellet was prepared by pressing the lithium foil 106, stamped out to have a diameter of 2 mm and thickness of 0.22 mm, to the negative electrode pellet 104. The separator 109 was of 0.2 mm thick non-woven fabric of glass fibers, dried and stamped out to have a diameter of 3 mm. The gasket 108 was of PPS. The electrolytic solution 107 was prepared by dissolving 1 mol/L of lithium borofluoride (LiBF₄) in a mixed solvent of ethylene carbonate (EC) and γ-butyrolactone (γBL), 1/1 by volume, and 6 μFL of the solution was put in the battery can. The positive electrode and negative electrode units were put one on another and sealed in the battery by caulking. A total of 2,000 batteries were produced by the above procedure.

These 2,000 batteries were heated in a reflow furnace by hot air following the heating profile, similar to that shown in FIG. 2.

One battery was ruptured and 2 showed leakage of the electrolytic solution. Examination of the battery characteristics found one battery of increased height, 3 batteries of increased internal resistance by 50% or more, and one battery of decreased voltage.

The positive electrode terminal 111 and negative electrode terminal 112 were welded by the aid of laser to each of the batteries which showed no abnormality, and the assembly was reflow-soldered to the substrate following the heating profile, similar to that shown in FIG. 2.

The reflow-soldered batteries were examined for their outer appearances and battery characteristics. None of them showed abnormality.

### EXAMPLES 2 to 17:

Examples 2 to 17 used MoO₃ and SiO as the positive electrode and negative electrode active materials, respectively. The positive electrode, negative electrode and electrolytic solution were prepared by the procedures described below. The battery was 4.8 mm in outer diameter and 1.4 mm thick. FIG. 1 presents its cross-sectional view.

In Examples 2 to 17, the mixture for positive electrode material was prepared by incorporating commercial MoO₃, after it was crushed, with graphite as the electroconductive agent and polyacrylic acid as the binder in a ratio of 53/45/2 by weight, and 5 mg of the mixture was pressed into a pellet, 2.4 mm in diameter, under pressure of 2 ton/cm². The positive electrode unit of monolithic structure was prepared, wherein the pellet 101 thus prepared and electrode collector 102 were assembled in and bound to the positive electrode case 103. It was treated at 250° C. under a vacuum for 8 hours for drying.

The liquid sealant was prepared by dissolving a commercial butyl rubber-based adhesive (comprising 30% by weight of butyl rubber and 70% by weight of toluene) and blown asphalt in toluene, spread over the inner surfaces of the positive electrode can by a syringe, and dried at 120° C. in a dry room. The sealant compositions for Examples 2 to 17 are given in Table 1.

The mixture for negative electrode material was prepared by incorporating commercial SiO as the working electrode active material, after it was crushed, with graphite as the electroconductive agent and polyacrylic acid as the binder in a ratio of 45/40/15 by weight, and 1.1 mg of the mixture was pressed into a pellet, 2.1 mm in diameter, under pressure of 2 ton/cm². The negative electrode unit of monolithic structure was prepared, wherein the pellet 104 thus prepared and electrode collector 2 composed of an adhesive of electroconductive resin with carbon as the electroconductive filler were assembled in and bound to the negative electrode case 105. It was treated at 250° C. under a vacuum for 8 hours for drying. The laminated electrode of lithium and negative electrode pellet was prepared by pressing the lithium foil 106, stamped out to have a diameter of 2 mm and thickness of 0.22 mm, to the negative electrode pellet 104. The separator 109 was of 0.2 mm thick non-woven fabric of glass fibers, dried and stamped out to have a diameter of 3 mm. The gasket 108 compositions are given in Table 1.

The electrolytic solution 107 was prepared by dissolving 1 mol/L of lithium borofluoride (LiBF₄) in a mixed solvent of ethylene carbonate (EC) and γ-butyrolactone (γBL), 1/1 by volume, and 6 μL of the solution was put in the battery can. The positive electrode and negative electrode units were put one on another and sealed in the battery by caulking. A total of 500 batteries were produced by the above procedure in each of Examples 2 to 17.

These 500 batteries were heated in a reflow furnace by hot air following the heating profile, similar to that shown in FIG. 2.

A voltage of 3.3 V was applied to each battery, and discharged to 2.0 V at 5 μA, after the battery was stored at 60° C. for 20 days, to measure discharge capacity. A total of 500 batteries were also prepared in Comparative Example 1, wherein the sealant was free of asphalt.

The results are given in Table 1.

TABLE 1

| | | Sealant of positive and | | | |
|---|---|---|---|---|---|
| | | negative electrode solutions | | Number of | |
| | | | Ratio of asphalt to | batteries that | Capacity after |
| | Gasket | | butyl rubber | caused liquid | storage |
| | material | Asphalt | (weight %) | leakage | (mAh) |
| Comparative | PPS | Straight | 0 | 5 | 0.18 |
| Example 1 | | | | | |
| Example 2 | PPS | Straight | 1 | 4 | 0.22 |
| Example 3 | PPS | Straight | 2 | 0 | 0.24 |
| Example 4 | PPS | Straight | 10 | 0 | 0.24 |
| Example 5 | PPS | Straight | 20 | 0 | 0.24 |
| Example 6 | PPS | Straight | 30 | 0 | 0.24 |
| Example 7 | PPS | Straight | 40 | 0 | 0.24 |
| Example 8 | PPS | Straight | 50 | 0 | 0.24 |
| Example 9 | PPS | Blown | 1 | 2 | 0.23 |
| Example 10 | PPS | Blown | 2 | 0 | 0.24 |
| Example 11 | PPS | Blown | 10 | 0 | 0.24 |
| Example 12 | PPS | Blown | 20 | 0 | 0.24 |
| Example 13 | PPS | Blown | 30 | 0 | 0.24 |
| Example 14 | PPS | Blown | 40 | 0 | 0.24 |
| Example 15 | PPS | Blown | 50 | 0 | 0.24 |
| Exam le 16 | PEEK | Blown | 10 | 0 | 0.24 |
| Example 17 | LCP | Blown | 10 | 0 | 0.24 |

Of the batteries prepared in Comparative Example 1, with the sealant free of asphalt, five showed leakage of the electrolytic solution. The batteries prepared in Comparative Example 1 had a lower discharge capacity than those prepared in the Examples, after they were stored under the above-described conditions. The batteries prepared in Examples 2 and 9 used the sealant containing asphalt, straight and blown respectively, at 1% by weight on the butyl rubber. Four batteries prepared in Example 2 and two prepared in Example 3 showed the leakage, indicating that blown asphalt has a better effect of leakage prevention than straight. No battery showed the leakage or deteriorated battery capacity after the storage, when the sealant contained asphalt at 2% by weight or more.

The battery had good characteristics even when the sealant contained asphalt at 50% by weight or more, but was sticky to the touch by the liquid sealant leaking out of the battery during the production process. Such a high content of asphalt, therefore, may deteriorate productivity.

Therefore, asphalt is serviceable when it is contained in the sealant at 2 to 50% by weight, bringing about the good effect especially at 5 to 10%.

Three types of gasket materials were used, PPS (Examples 2 to 15), PEEK (Example 16) and LCP (Example 17), all of which are known as hard materials. A combination of the sealant and heat treatment for the present invention is found to control leakage of the electrolyte and maintain the battery characteristics, even with the gasket of such a hard material. The suitable asphalt content was 2 to 50% by weight also with the PEEK and LCP gaskets, although not shown in Table 1. (Examples 18, 19) By the same procedure as Example 4 except that polypropylene (PP) was used in place of the gasket material, batteries using the sealing agent of straight asphalt were prepared. A half of the batteries were heated to 80° C. for one hour to make Example 18 and rests were used as Comparative Example 2.

By the same procedure as Example 11 except that polypropylene (PP) was used in place of the gasket material, batteries using the sealing agent of blown asphalt were prepared. A half of the batteries were heated to 100° C. for 30 minutes to make Example 19 and the rests were used as Comparative Example 3.

To the batteries of Comparative Examples 2, 3 and Examples 18, 19 was applied a voltage of 3.3 V, and a storage test was practiced under the atmosphere of 60° C. and 90% in humidity. By comparing the capacity after the test with the capacity at the beginning, the capacity maintaining ratio was calculated. As the results thereof, the capacity maintaining ratio was 58% in Comparative Example 2, 61% in Comparative Example 3, 96% in Example 18, and 95% in Example 19. As shown in the results after storing Examples 18 and 19, in the case of heating the batteries, the storage characteristics were greatly improved. It is considered that at heating the battery, the adhesion of the sealing agent and the battery gasket was improved to prevent the entrance of water from outside. The heating temperature, can be established low a little for the battery using straight asphalt having a low softening point.

A coin-shaped (or button-shaped) non-aqueous electrolyte secondary battery capable of being assembled by reflow soldering may suffer troubles resulting from fluctuations during the production process, e.g., blister, leakage of the electrolytic solution and even rupture of the battery at the worst during the reflow-soldering step to mount the battery on the substrate. The battery of the present invention, delivered after being heat-treated, causes neither blister nor leakage of the electrolyte, when reflow-soldered at the customer. Incorporation of asphalt in the liquid sealant improves sealing characteristics of the heat-treated battery of the present invention, greatly improving its storage and liquid leakage resistance characteristics.

What is claimed is:

1. A method of producing a non-aqueous electrolyte secondary battery having the positive electrode, negative electrode, electrolytic solution containing a non-aqueous solvent and supporting salt, separator and gasket, comprising a step of assembling and sealing said positive electrode, negative electrode, non-aqueous solvent, electrolytic solution, separator and gasket in said non-aqueous electrolyte secondary battery by caulking, and step of heating.

2. The method of producing a non-aqueous electrolyte secondary battery according to claim 1, wherein said battery is provided with connecting terminals by welding to connect itself to an outside device.

3. The method of producing a non-aqueous electrolyte secondary battery according to claim 1, wherein said battery is heated at 180 to 300° C. in the heating step.

4. A method of mounting a non-aqueous electrolyte secondary battery on a circuit substrate, comprising a step of assembling and sealing the positive electrode, negative electrode, non-aqueous solvent, electrolytic solution, separator and gasket in said non-aqueous electrolyte secondary battery by caulking, step of heating, and reflow soldering step to mount said non-aqueous electrolyte secondary battery on said circuit substrate on which it is set.

5. The method of mounting a non-aqueous electrolyte secondary battery according to claim 4, which comprises a step of welding connecting terminals to said battery, after it is assembled.

6. The method of mounting a non-aqueous electrolyte secondary battery according to claim 4, wherein the difference between the temperature-time profile during the heating step and that during the reflow soldering step is within ±50% in a heating region of 0 to 150° C.

7. The method of mounting a non-aqueous electrolyte secondary battery according to claim 4, wherein the difference between heating step time and reflow soldering step time is within ±50% in a heating region of 0 to 150° C.

8. The method of mounting a non-aqueous electrolyte secondary battery according to claim 4, wherein the difference between the temperature-time profile during the heating step and that during the reflow soldering step is within ±20% in a heating region of 150 to 180° C.

9. The method of mounting a non-aqueous electrolyte secondary battery according to claim 4, wherein the difference between heating step time and reflow soldering step time is within ±20% in a heating region of 150 to 180° C.

10. The method of mounting a non-aqueous electrolyte secondary battery according to claim 4, wherein the difference between the temperature-time profile during the heating step and that during the reflow soldering step is within ±10% in a heating region of 180 to 300° C.

11. The method of mounting a non-aqueous electrolyte secondary battery according to claim 4, wherein the difference between heating step time and reflow soldering step time is within ±10% in a heating region of 180 to 300° C.

12. A sealant of rubber-based adhesive with asphalt on the surface for the non-aqueous electrolyte secondary battery.

13. The sealant for the non-aqueous electrolyte secondary battery according to claim 12, wherein said asphalt is a distillate of heated crude oil.

14. The sealant for the non-aqueous electrolyte secondary battery according to claim 12, wherein said rubber-based adhesive also has said asphalt inside.

15. The sealant for the non-aqueous electrolyte secondary battery according to claim 12, wherein said asphalt is present at 1 to 50%, inclusive, in the rubber-based adhesive.

16. The sealant for the non-aqueous electrolyte secondary battery according to claim 12, wherein said asphalt is present at 5 to 20%, inclusive, in the rubber-based adhesive.

17. The sealant for the non-aqueous electrolyte secondary battery according to claim 12, wherein said asphalt is blown asphalt.

18. The sealant for the non-aqueous electrolyte secondary battery according to claim 12, wherein said asphalt is straight asphalt.

19. The sealant for the non-aqueous electrolyte secondary battery according to claim 12, wherein said rubber-based adhesive is butyl rubber-based.

20. A sealant for the non-aqueous electrolyte secondary battery product by mixing an asphalt with rubber-based adhesive in the presence of an organic solvent.

21. A method of producing sealant for non-aqueous electrolyte secondary battery comprising: mixing rubber-based adhesive and asphalt in organic solvent.

22. The method of producing sealant for non-aqueous electrolyte secondary battery, wherein the rubber-based adhesive is butyl rubber-based.

23. The method of producing sealant for non-aqueous electrolyte secondary battery, further comprising heating after the mixing.

24. The method of producing sealant for the non-aqueous electrolyte secondary battery according to claim 21, wherein said organic solvent is toluene.

25. A method of producing a non-aqueous electrolyte secondary battery comprises a step of assembling and sealing the positive electrode, negative electrode, non-aqueous solvent, electrolytic solution, separator and gasket in said non-aqueous electrolyte secondary battery by caulking, after a solution of the rubber-based adhesive and asphalt dissolved in an organic solvent is spread over the inner surfaces of the positive electrode can and a surface of a gasket contact with a surface of negative electrode, and dried, and step of heating.

26. The method of producing a non-aqueous electrolyte secondary battery according to claim 25, wherein said asphalt is straight asphalt.

27. The method of producing a non-aqueous electrolyte secondary battery according to claim 26, wherein said solution is dried at range from 80° C. to lower than melting point of the gasket.

28. The method of producing a non-aqueous electrolyte secondary battery according to claim 25, wherein said asphalt is blown asphalt.

29. The method of producing a non-aqueous electrolyte secondary battery according to claim 28, wherein said solution is dried at range from 100° C. to lower than melting point of the gasket.

30. The method of producing a non-aqueous electrolyte secondary battery according to claim 25, wherein the battery can surface is marked to show that the heating step is over.

31. A non-aqueous electrolyte secondary battery having the positive electrode, negative electrode, electrolytic solution containing a non-aqueous solvent and supporting salt, separator, gasket and connecting terminals which connects said battery to an outside device, which is marked to show that it is subjected heating once during the production process.

32. A non-aqueous electrolyte secondary battery having the positive electrode, negative electrode, electrolytic solution containing a non-aqueous solvent and supporting salt, separator and gasket, wherein it is heated at an around reflow temperature.
